(19) United States
(12) Patent Application Publication
(10) Pub. No.: US 2015/0067037 A1
(43) Pub. Date: Mar. 5, 2015

(54) COMMUNICATION APPARATUS AND COMMUNICATION METHOD

(71) Applicant: KABUSHIKI KAISHA TOSHIBA, Tokyo (JP)

(72) Inventor: Takeshi ISHIHARA, Yokohama (JP)

(21) Appl. No.: 14/477,207

(22) Filed: Sep. 4, 2014

(30) Foreign Application Priority Data
Sep. 5, 2013 (JP) 2013-183986

(51) Int. Cl. H04L 29/08

(52) U.S. Cl. CPC H04L 67/2857; H04L 67/02
USPC 709/203

(57) ABSTRACT

There is provided a communication apparatus, including: a storage, a transmitter, a receiver and an updater. The storage stores object information including first to N-th elements, and first to N-th update information identifiers identifying versions of the first to N-th elements. The transmitter transmits an acquisition request including all or a part of the first to N-th update information identifiers to an acquisition target apparatus via a network. The receiver receives, from the acquisition target apparatus, first update information to update at least one element among the elements whose update information identifiers were transmitted in the acquisition request and second update information to update the update information identifier of the at least one element. The updater updates the at least one element in the storage with the first update information and updates the update information identifier of the at least one element with the second update information.

### CROSS-REFERENCE TO RELATED APPLICATIONS

This application is based upon and claims the benefit of priority from Japanese Patent Application No. 2013-183986, filed Sep. 5, 2013; the entire contents of which are incorporated herein by reference.

### FIELD

Embodiments described herein relate to a communication apparatus and a communication method.

### BACKGROUND

A method for accessing information on the Internet by using web browsers is widely used. The web browsers acquire information from web servers on the Internet by using Hyper Text Transfer Protocol (HTTP). The basic operation of the web browsers is constituted of transmitting a request including a Uniform Resource Identifier (URI) that identifies desired information and receiving a response from a server.

While this basic operation is performed for all the requests in principle, it is inefficient to re-acquire information when the information is not updated on the server side. Accordingly, a cache mechanism and/or a difference transfer scheme are made available. When acquisition of a certain information piece is interrupted on the way, a range request scheme is also made available to request only an interrupted portion.

The HTTP cache mechanism handles URIs as units of information. More specifically, even in the case where only a small part of the information identified by a certain URI is changed, the entire information needs to be updated.

This poses a problem when the information includes dynamically generated information. For example, consider the case where a web page made up of a menu portion that is statically formed and a display portion that displays the state of a user's mail box. In this case, the entire web page is regarded as a cache unit. Since the state of the mail box may change in every access, it becomes necessary to re-acquire the entire web page that includes the menu portion formed of fixed information.

### BRIEF DESCRIPTION OF THE DRAWINGS

FIG. 1 illustrates a network system according to a first embodiment;

FIG. 2 is a block diagram illustrating a terminal device and an information providing apparatus according to the first embodiment;

FIG. 3A is a flow chart illustrating information request operation performed by the terminal device;

FIG. 3B is a flow chart illustrating information request operation performed by the terminal device;

FIG. 4A illustrates examples of HTML documents, tree structures, elements, and update information identifiers;

FIG. 4B illustrates examples of HTML documents, tree structures, elements, and update information identifiers;

FIG. 4C illustrates examples of HTML documents, tree structures, elements, and update information identifiers;

FIG. 5 illustrates a message sequence between the terminal device and the information providing apparatus;

FIG. 6 illustrates an operating sequence in the case where a server dynamically generates and changes an HTML document;

FIG. 7 is a block diagram illustrating a terminal device according to a second embodiment;

FIG. 8 illustrates a message sequence according to the second embodiment;

FIG. 9 illustrates a network configuration according to a third embodiment;

FIG. 10 is a block diagram illustrating an information providing apparatus according to the third embodiment;

FIG. 11 illustrates an operating sequence according to the third embodiment; and

FIG. 12 illustrates an example of management information.

### DETAILED DESCRIPTION

According to one embodiment, there is provided a communication apparatus, including: a storage, a transmitter, a receiver and an updater.

The storage stores object information including first to N-th elements, and first to N-th update information identifiers identifying versions of the first to N-th elements.

The transmitter transmits an acquisition request including all or a part of the first to N-th update information identifiers to an acquisition target apparatus via a network.

The receiver receives, from the acquisition target apparatus, first update information to update at least one element among the elements whose update information identifiers were transmitted in the acquisition request and second update information to update the update information identifier of the at least one element.

The updater updates the at least one element in the storage with the first update information and updates the update information identifier of the at least one element with the second update information.

Hereinafter, embodiments of the present invention will be described with reference to the accompanying drawings.

### First Embodiment: Basic Embodiment of Terminal Device and Server Capable of Managing Information with Document Object Model (DOM) and the Like

In the present embodiment, information such as document information is interpreted and structurized so that information update is managed in units of a document element, i.e., units of an element in data structure. Change in respective elements (also referred to as logical elements) is made detectable, and only those elements that have that change are acquired from the server. As a result, it becomes possible to efficiently acquire information including a dynamically generated portion while effectively using the cache mechanism with respect to an unchanged portion. Hereinafter, the details of the present embodiment will be described.

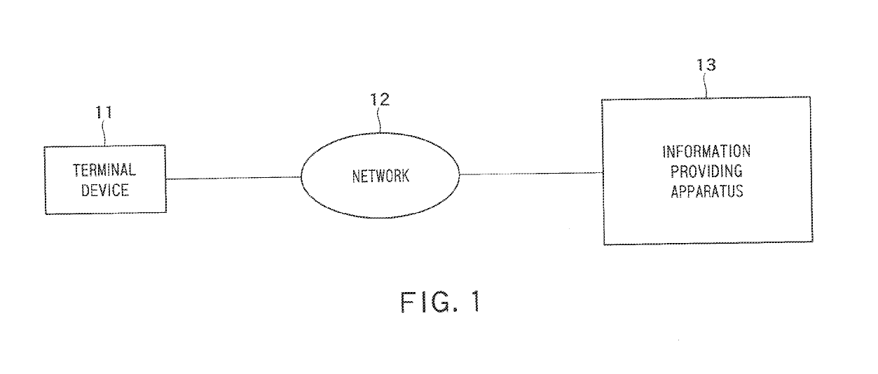

FIG. 1 illustrates a network system according to the present embodiment. A terminal device 11 is connected to an information providing apparatus 13 via a network 12. Although only one terminal device and one information providing apparatus are illustrated, two or more apparatuses may respectively be provided. The present embodiment will be described with each one apparatus being provided. The terminal device 11 and the information providing apparatus 13 respectively represent one embodiment of a communication apparatus which can communicate via a network. The information providing apparatus 13 is an apparatus, such as a web server, to provide information to the terminal device 11. From the viewpoint of the terminal device 11, the information providing apparatus 13 is an acquisition target apparatus to acquire information. From the viewpoint of the information providing apparatus 13, the terminal device 11 is a request source apparatus that requests information.

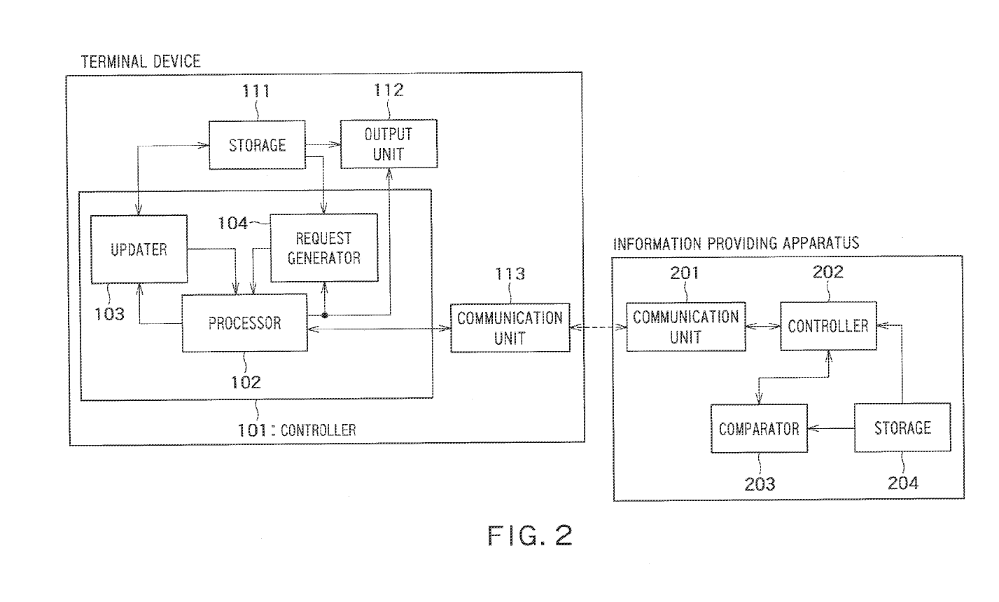

FIG. 2 is a configuration diagram illustrating a terminal device and an information providing apparatus in the first embodiment.

The terminal device includes a controller 101, a communication unit 113, a storage unit (memory unit) 111, and an output unit 112. The controller 101 includes a processor 102, a request generator 104, and an updater 103.

The communication unit 113 executes various communication processes necessary for communicating with the information providing apparatus. The communication unit 113 is, for example, a TCP/IP protocol stack and/or a network interface and the like.

The processor 102 manages all over the various processes executed in the terminal device. Examples of the various processes include a communication process performed with the information providing apparatus via a network, a storing process to store acquired information as a cache for reuse, and a display process to display the acquired information.

The storage 111 is a memory unit to store data as a cache. The memory unit is a memory device which may be formed from a volatile memory or from a nonvolatile memory. The storage 111 stores information, such as HTML documents provided from the information providing apparatus, as object information. The object information is constituted of a plurality of elements. The storage 111 stores identifiers of respective elements and update information identifiers identifying versions of the respective elements. For example, the HTML documents are converted into tree-structure data such as DOM data and managed in this form. Elements are allotted to respective nodes of the tree structure. When information is acquired from the information providing apparatus, the information is stored as a cache in the storage 111. Identifiers of the respective elements may be values identifying the position of the nodes having the respective elements allotted thereto (described in detail later). When information, such as an HTML document, is acquired from the information providing apparatus, update information identifiers of the respective elements are simultaneously received together with the information.

The request generator 104 generates a message (information acquisition request) requesting acquisition of information to the information providing apparatus. In that case, a message in accordance with a special format defined in the present embodiment may be generated. The information acquisition request includes update information identifiers identifying respective versions of the plurality of elements that constitute information (object information) managed by the terminal device, and identifiers of the respective elements. These identifiers are acquired by reading out from the storage 111. However, when the object information has never been acquired before, i.e., when an URI which is a target to acquire the object information has not yet been accessed and the object information has not yet been cached in the storage 111, an information acquisition request excluding the identifiers and the update information identifiers of the respective elements is transmitted.

The updater 103 analyzes a response to the information acquisition request acquired from the information providing apparatus, and updates the information cached in the storage 111 of the terminal device as necessary. The response acquired from the information providing apparatus includes update information (first update information) adapted to update elements to be updated, among the plurality of elements whose update information identifiers were transmitted in the information acquisition request. The response also includes update information (second update information) adapted to update the update information identifiers of the elements. The elements to be updated are the elements whose versions are older than the versions of the elements having the same identifiers in the information of the pertinent URI managed by the information providing apparatus. The first update information may be data on updated elements themselves, or may be difference data when the elements can differentially be updated. The second update information may be update information identifiers representing updated versions or may be incremental values when the version is expressed in the form of a sequentially incremented value. When the information acquisition request excluding the update information identifiers is transmitted from the terminal device to the information providing apparatus, a response including the entire information placed at the position of the URI is received. The response includes the update information identifiers indicating the versions of respective elements constituting the information, and identifiers of the respective elements.

The output unit 112 displays the information (object information) stored in the storage 111 for a user of the terminal device.

The terminal device may include component members other than those described in the foregoing. Since these component members are not directly related to the present embodiment, a description thereof is omitted here.

The information providing apparatus includes a communication unit 201, a controller 202, a comparator 203, and a storage (memory unit) 204.

The communication unit 201 receives a request from the terminal device via a network, and performs a communication process necessary for transmitting a response. For example, a TCP/IP protocol stack and/or a network interface performs the process.

The storage 204 stores information associated with an URI. The information includes a plurality of elements. The information to be stored may be of a specific URI. When the information corresponds to a plurality of URIs, the information may be stored per URI. The storage 204 also stores the update information identifiers identifying each version of the plurality of elements that constitute the information corresponding to an URI, and/or a hierarchical structure of the information.

The controller 202 manages the information in the storage 204, analyzes the information acquisition request received from the terminal device, and/or generates a response to be transmitted to the terminal device.

When all or a part of the information corresponding to the URI is updated in the storage 204, the controller 202 rewrites pertinent elements and updates (i.e., changes the versions of) the update information identifiers of the elements. Such information update is managed by a later-described controller 202. The version may be a value sequentially incremented like 1, 2, 3, . . . in each update, a value identifying update date and time, or a value of other kinds.

When an acquisition request of the entire information (acquisition request excluding update information identifiers and the like) is made by the terminal device, the controller 202 reads out the entire information stored in the position of a relevant URI from the storage 204, and sends a response including the read-out information to the terminal device. In this case, the update information identifiers of the respective elements constituting the information are also included in the response.

The comparator 203 compares the update information identifiers of the respective elements included in the information acquisition request received from the terminal device with the update information identifiers of the respective elements in the information corresponding to the relevant URI stored in the storage 204. It is determined whether the update information identifiers are matched or mismatched for each element. The elements of the terminal device detected to be mismatched are specified as elements to be updated, and the identifiers of the specified elements are notified to the controller 202.

The controller 202 reads out elements having the identifiers identical to the identified elements among the respective elements in the information corresponding to the URI, and update information identifiers of the elements, from the storage 204. The controller 202 then generates a response including the read-out data, and transmits the response to the terminal device via the communication unit 201.

The information providing apparatus may include component members other than those described in the foregoing. Since these component members are not directly related to the present embodiment, a description thereof is omitted here.

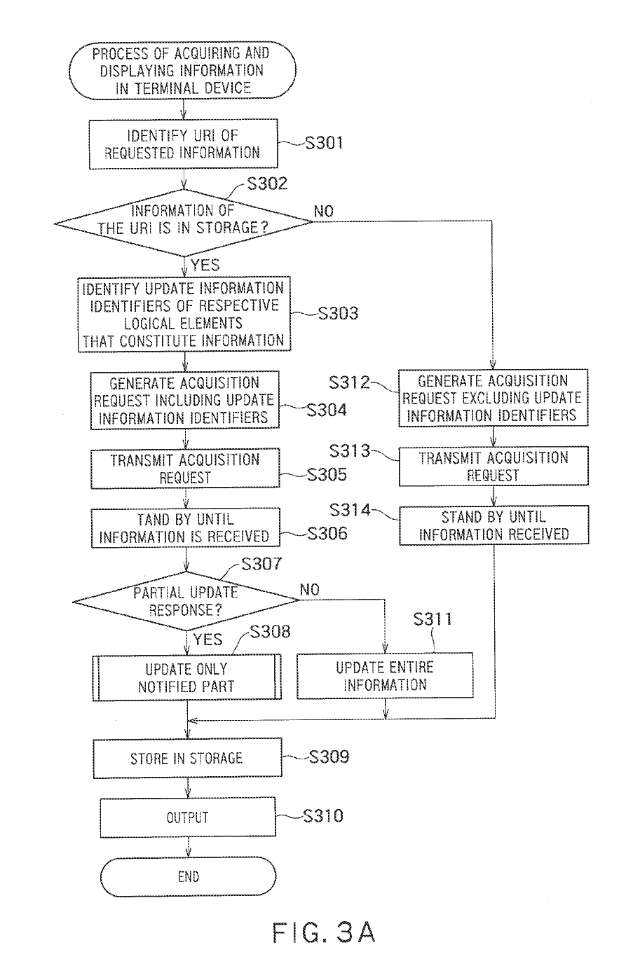

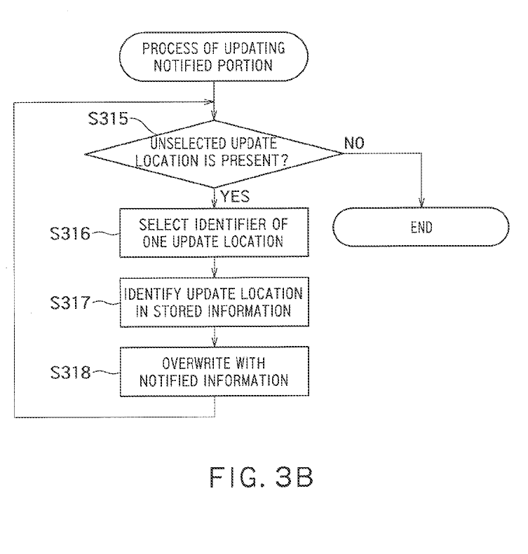

FIG. 3A illustrates a flow chart of information request operation in this terminal device.

The information acquisition operation starts by identifying an URI of the requested information (S301). This operation may be executed by such operation as a user selecting a link displayed on a web browser for example. In addition, the operation may also be executed when acquisition of information at a certain URI is requested by an external program. The external program, the user, or operating unit such as a mouse operated by the user are request sources that specify an URI.

Once the URI is identified, a cache state of the information (object information) identified by the URI is confirmed (S302). When there is a valid cache in the storage 111 (S302—YES), a process (S303 to S311) based on the characteristics of the present embodiment is performed. When there is no cache, a whole page (entire information) is acquired and a display process is performed (S312 to S314, S309, S310).

The process (S303 to S311) based on the characteristics of the present embodiment is described in detail. When the valid cache of the information of the URI identified in step S301 is present in the storage 111 (S302—YES), the information is acquired with reference to the storage 111. Then, update information identifiers indicating version information of the respective elements that constitute the information are identified (S303).

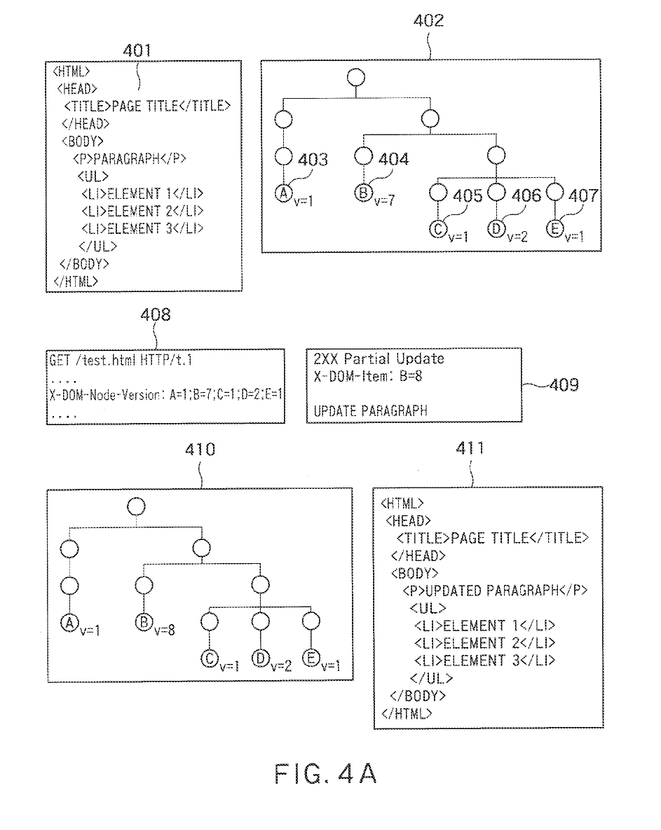

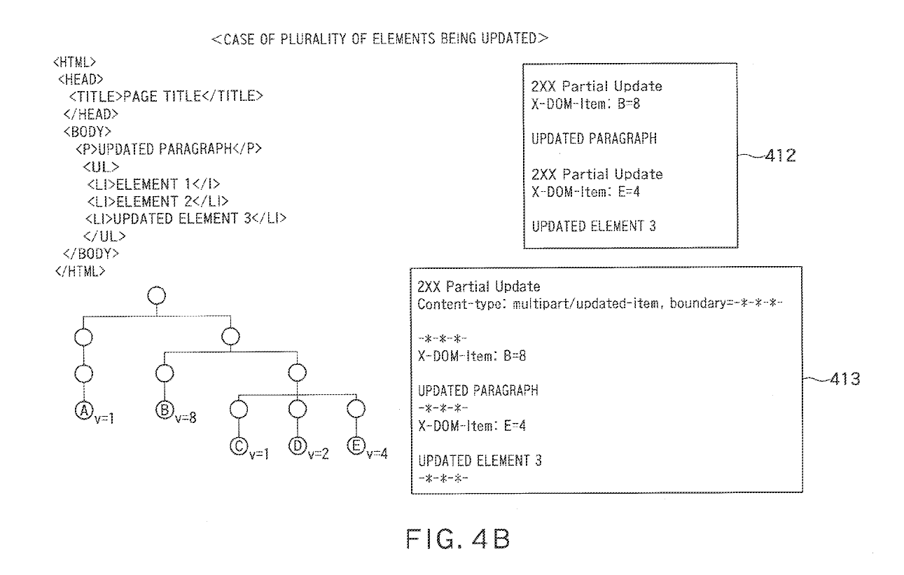

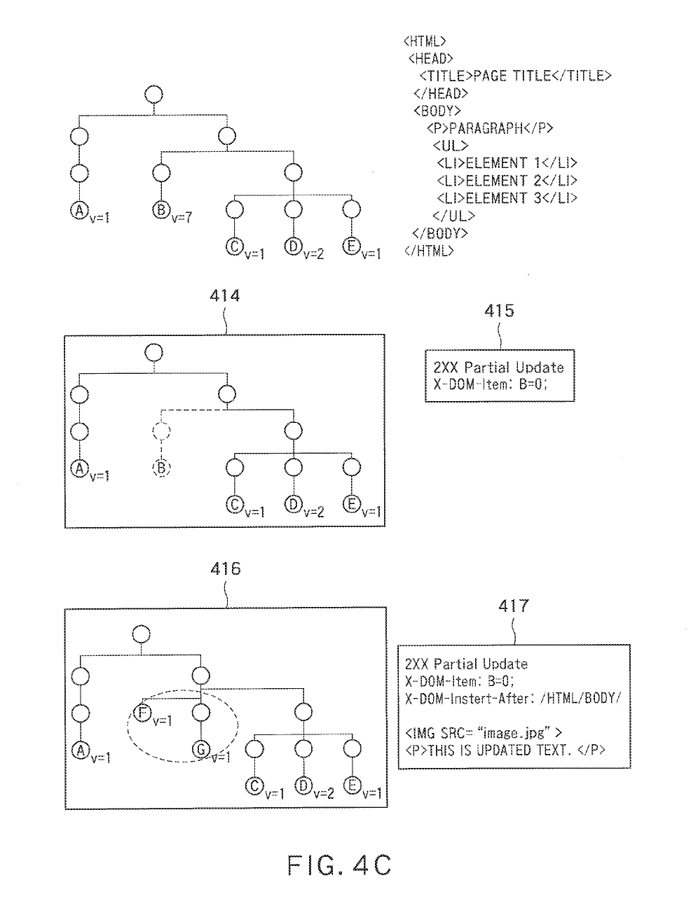

FIG. 4 illustrates an example 401 of an HTML document as the information corresponding to the URI requested by the terminal device. This information 401 is cached in the storage 111. In other words, the information 401 has been acquired before at the same URI. It is assumed that a tree structure 402 is obtained as a result of analyzing the HTML document 401. The analysis thereof is conducted by the controller 101. A similar tree structure is also managed on the side of the information providing apparatus. Update information identifiers in the form of v=N (“N” being a numeric character) are each allotted to respective elements of the tree structure 402. The numeric character “N” corresponds to a value of the update information identifier. The expression v=N indicates that the element having the update information identifier allotted thereto has a version of “N.” In this example, the update information identifiers are allotted only to the terminal elements (403 to 407), though the update information identifiers may also be allotted to intermediate nodes in the same manner. In step S303, all of these update information identifiers allotted to the nodes in the tree structure are identified. In the drawing, reference characters “A”, “B”, “C”, “D”, and “E” denote identifiers identifying the location of the nodes, i.e., identifiers of the elements. Here, the identifiers are schematically expressed with “A”, “B”, “C”, “D”, and “E.” Any method can be used for allotment of the identifiers as long as positions in a hierarchical structure can be identified and both the terminal device and the information providing apparatus support the same method. For example, identifiers like “A”, “B”, “C” . . . may be allotted to the nodes based on a predetermined rule, or identifiers may be allotted by using HTML tags corresponding to the nodes. Master-slave relationship between the nodes may be used to allot identifiers to the nodes, like a first slave, a second slave of a given node. In short, any method can be employed as long as both the terminal device and the information providing apparatus can use the same method and can commonly identify the respective elements.

Once all the update information identifiers are identified, an information acquisition request, including the identifiers and update information identifiers of the respective elements, is generated (S304). For example, a request 408 illustrated in FIG. 4A is generated as a request for the HTML document 401. In this request, the update information identifiers of the elements are notified by using a user definition HTTP header “X-DOM-Node-Version.” The HTTP header “X-DOM-Node-Version” expresses the update information identifiers of the respective elements as a list of “element identifier (update location identifier)=update information identifier” separated with semicolons. For example, A=1 indicates that the element A has a version of 1. Note that this format is merely one example of presentation, and other formats may be used as long as the same context can be expressed.

Once the information acquisition request, including the update information identifiers of the respective elements and the like, is generated, the request is transmitted to the information providing apparatus (S305). Then, the terminal device waits until a response is received from the information providing apparatus (S306). The content of the response differs depending on whether the information providing apparatus conforms to partial update. Accordingly, the terminal device that received the response needs to change processes in accordance with whether the information providing apparatus conforms to the partial update. The information providing apparatus which conforms to the partial update is the information providing apparatus according to the present embodiment, while the information providing apparatus which does not conform to the partial update is a general information providing apparatus.

Accordingly, the terminal device which received the response confirms whether or not the information providing apparatus conforms to the partial update (S307). If the information providing apparatus conforms to the partial update (S307—YES), the terminal device updates, based on the received response, only the elements which have a change among the plurality of elements that constitute the HTML document in the storage 111 (S308). As a consequence, the HTML document stored in the storage 111 is updated (S309).

If the information providing apparatus does not conform to the partial update (S307—NO), the requested HTML document is included in the response as a whole. Consequently, the terminal device updates the entire HTML document (S311). As a result, the HTML document stored in the storage 111 is updated (S309).

Once the HTML document stored in the storage 111 is updated, the HTML document is outputted via the output unit 112 (S310).

Next, the details of the partial update performed in the process of step S308 will be described. It is assumed, for example, that a response 409 illustrated in FIG. 4 is received as a response in the case where the information providing apparatus conforms to the partial update. This response is made up of three portions. The first portion includes a special response code expressing “this is partial update” (2XX: a numeric character is inserted into “X” in actuality), and a character string (1st line) “Partial Update” that indicates the same. The second portion includes a user definition header “X-DOM-Item” (2nd line), which indicates an update location and its version. The expression “B=8” expresses that the element at the location B (i.e., element B) has an updated update information identifier (version) of 8. The third portion includes an actual update content (4th and subsequent lines). It is indicated that the content of the update element B is “updated paragraph”, and the “paragraph” surrounded with tags <P> and </P> in the HTML document 401 is overwritten with the “updated paragraph.”

Whether or not the information providing apparatus conforms to the partial update in step S307 is determined with reference to the 1st line of the response. When the response indicates conformity to the partial update, the elements (only the element B in the case of the response 409) at the locations notified in the response are updated in step S308.

FIG. 3B illustrates a flow chart of the process of step S308 (S315 to S318).

First, it is confirmed whether there is any update location not yet selected among the update locations listed in the X-DOM-Item header in the received response (S315). When there is any update location not yet selected (S315—YES), the update location is selected (S316). In the example of a response 409 illustrated in FIG. 4, “X-DOM-Item: B=8” is stated. Since the location B is the only one update location, the update location B is selected. Then, the HTML document stored in the storage 111 is read out, and the element at the location B is identified by creating DOM data (see the example 402) and the like (S317). Note that the DOM data created in advance may be stored in the storage 111, and the stored DOM data may be read out. Then, the content of the element B is overwritten with a content notified in a body portion of the response message (a portion described in the “updated paragraph” in the response 409) (S318). As a result, an updated tree structure (DOM data) 410 and an updated HTML document 411 illustrated in FIG. 4 can be obtained.

The above process is repeated until there is no unselected update location. In the example of the response 409 in FIG. 4, there is only one update location, though a plurality of update locations may be notified. In that case, as in the case of the request 408 in FIG. 4, the update information identifiers of a plurality of elements are dividedly listed in the form of “update location identifier (element identifier)=update information identifier” in the “X-DOM-Item” header. Update portions (updated elements) included in the response are sequentially placed in a row in a body region (“updated paragraph”). Therefore, the plurality of update locations may also be processed in the same way as described before.

In another method, the terminal device may receive from the information providing apparatus an HTTP response in which respective elements to be updated are partitioned with headers. FIG. 4B illustrates a response example 412 in that case. Or alternatively, the terminal device may receive a response divided into a plurality of subdivisions in conformity with MIME/Multipart formats. FIG. 4 illustrates a response example 413 in that case. Illustrated on the left-hand side of FIG. 4 are examples of an HTML document and DOM data updated in accordance with the response 412.

While the case of updating only the terminal elements of the DOM data (tree structure) has been described, there are cases where a document may be updated on a larger-scale. Such larger-scale update may similarly be controlled by writing changes in the “X-DOM-Item” header.

For example, consider the case of notifying an update that is deletion of a certain element. In this case, under the rule that element deletion is expressed by version=0, the element at a position B is deleted upon reception of a response including a header “X-DOM-Item: B=0.” FIG. 4C illustrates a response example 415 in this case and DOM data 414 in which the element B is deleted. Illustrated on the top of FIG. 4C are DOM data before update and an HTML document before update.

In the case of deleting an element and then adding an element, a response may be received which includes a header like “X-DOM-Insert-After: /HTML/BODY/” and which further includes a location path in XPATH (which expresses the structure of an HTML document and identifies an update location) and an update content. FIG. 4C illustrates a response example 417 in this case. DOM data 416 is updated in accordance with the response 417. In the DOM data 416, the element B is deleted, and elements F and G are added. Data of the element F is image data of an “image.jpg” file, and data of the element G indicates that “this is updated text.” Processes not described in the drawing (Replace, and Insert-Before) may similarly be executed.

Furthermore, in some cases, the terminal device transmits some information, such as parameters, to the information providing apparatus, and the information providing apparatus dynamically generates and changes an HTML document based on the information. In such cases, when caching an HTML document in the storage 111, the terminal device may also store the information on the transmitted parameter together with the HTML document, and may generate and transmit an information acquisition request accompanied by the parameter value at the time of making a request again.

When the parameter value is changed, not only an old parameter but also a new parameter may be added and transmitted. In that case, in consideration of difference between the old and new parameters, the information providing apparatus side may generate update information (first and second update information) and then may return a response including the update information. Naturally, not the old parameter but only the new parameter may be transmitted and the entire HTML document may be requested as usual.

The foregoing is a flow of the process in the terminal device in the first embodiment.

### Supplennent to First Embodiment: Sequence Including Information Providing Apparatus

A description is now given of a flow of the entire process including the information providing apparatus in the first embodiment.

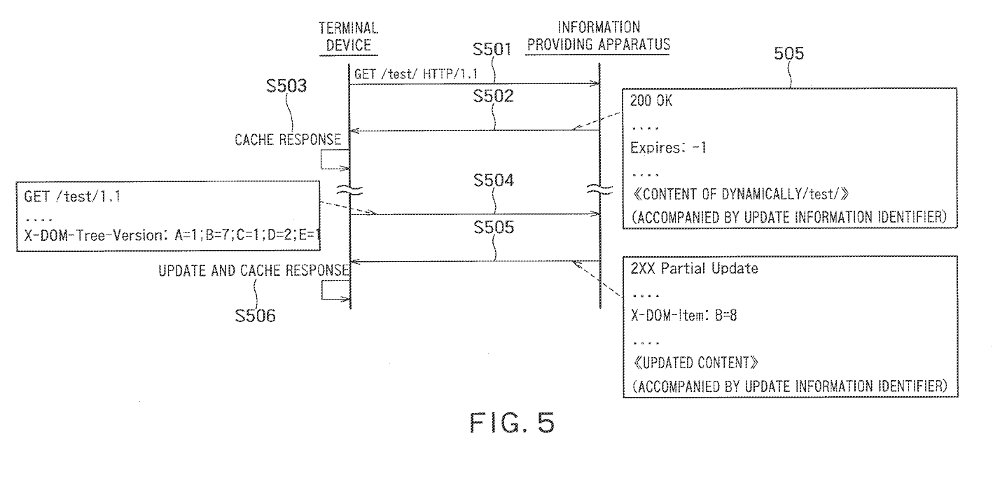

FIG. 5 illustrates a message sequence between the terminal device and an information providing apparatus. The information providing apparatus has a possibility of communicating with a large number of terminal devices in addition to the terminal device of the embodiment. In that case, message exchange similar to the message exchange performed with the terminal device of the embodiment is performed with these terminal devices.

First, the terminal device requests an information providing apparatus (herein a web server) to acquire an HTML document (S501). It is assumed that the document is dynamically generated by the server. In response to the request, the information providing apparatus dynamically generates an HTML document and sends back the generated HTML document (S502). In this case, when a header “Expires:−1” is imparted as illustrated in a response 505, the terminal device cannot normally cache the HTML document included in the response (when a valid positive number is set as a value of Expires, the value is used as a validity term of the document in the cache). However, the terminal device of the embodiment confirms that update information identifiers are included in the HTML document, and then caches the HTML document included in the response in the storage 111 (S503). The update information identifiers in the HTML document are associated with corresponding locations (nodes) in the HTML document and included in the HTML document.

Then, when accessing the same URI again, the terminal device generates and transmits an information acquisition request including the update information identifiers of a part or all of the plurality of elements that constitute the HTML document (S504). In the illustrated example, A=1, B=7, C=1, D=2, E=1 are notified as the update information identifiers of a part of the elements. More specifically, the element A has a version of 1, the element B has a version of 7, the element C has a version of 1, the element D has a version of 2, and the element E has a version of 1.

The information providing apparatus which received the notification compares versions of the elements, among the elements of the HTML document held in the information providing apparatus, whose identifiers are matched with the element identifiers notified by the terminal device, with the versions of the elements notified by the terminal device. When the versions differ, a response including the elements held in the information providing apparatus and their update identifiers is returned (S505). In the example illustrated in FIG. 5, at least the version of the element B is different between the terminal device and the information providing apparatus. Accordingly, a response including a content of the element B in the HTML document held in the information providing apparatus and the version of the element B is returned.

Then, the terminal device updates a cached content by using the received response, and again caches the result thereof (S506). In other words, the content of the element B is overwritten with the content of the updated element B included in the response, and the update information identifier of the element B is overwritten with the update information identifier (8 in this case) included in the response.

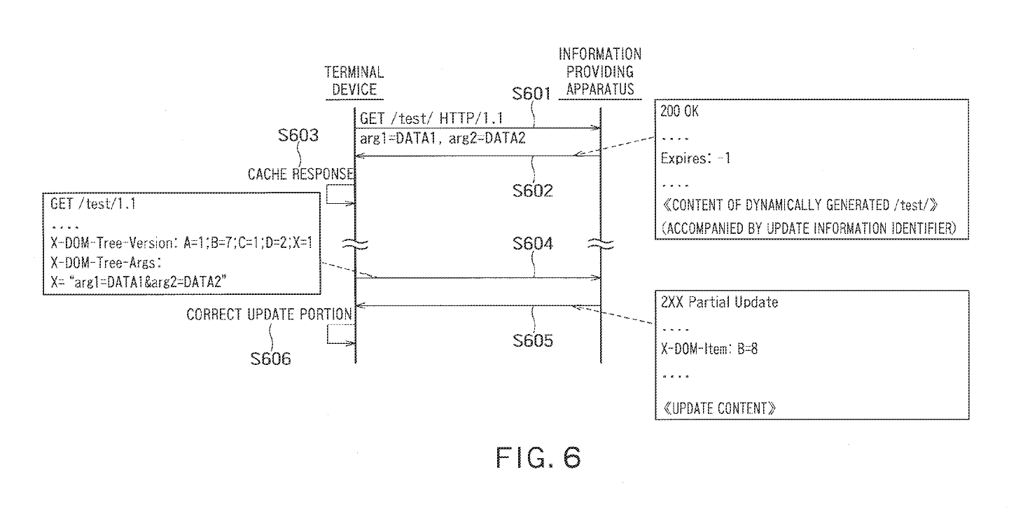

Similarly, FIG. 6 illustrates an operation sequence in the case where the terminal device transmits some information, such as parameters, to the information providing apparatus, and the server dynamically generates and changes an HTML document.

First, an HTML document (assumed to be dynamically generated) which can be identified with URL/test/ is acquired. In acquisition of this document, parameters “arg1” and “arg2” are required, and these two parameters are specified in a first request (S601). In the illustrated example, DATA1 is specified as the parameter “arg1” and DATA2 is specified as the parameter “arg2.”

The terminal device receives this response (S602). At that time, if it is confirmed that the response includes the update information identifiers of elements, data (such as update information identifiers, and a content of dynamically generated /test/) included in the response is cached together with the transmitted parameters (arg1=DATA1, arg2=DATA2) (S603).

Then, when the terminal device accesses the same URL, a request including the parameters stored in step S603 and the cached update information identifiers of the elements is transmitted (S604). In the illustrated example, A=1, B=7, C=1, D=2, E=1 are notified as the update information identifiers of the elements.

The information providing apparatus confirms the update information identifiers of the elements and values of the parameters notified by the terminal device, and identifies elements to be updated and the like. The information providing apparatus then generates and returns a response (S605). In the example illustrated in FIG. 6, at least the element B is identified as an update target, and a response including the element B and its update information identifier held in the information providing apparatus is returned.

The terminal device which received the response overwrites the elements to be updated and their update information identifiers with the content included in the response in a similar manner as before. Consequently, the cached document is updated again (S606).

In the sequence of FIG. 6, the parameters and their values are transmitted respectively. However, in such cases where there are a large numbers of parameters, and/or a parameter value consists of a long text, an request of acquiring update information may possibly be extremely large in size. In such a case, these parameter values may be transmitted as hash values and/or may be encoded to reduce the size of the request.

In the above description, the information providing apparatus imparts the “Expires” header to the response sent to the terminal device in order to control the cache of the HTML document (see FIGS. 5 and 6). Since the HTTP prescribes other cache control methods, cache control may be performed by these other methods.

For example, an HTML document version is imparted to a response coming from the information providing apparatus by using “Etag” headers. An “If-Match” header is imparted to an acquisition request from the terminal device, and a version (first update information identifier) of the HTML document held in the terminal device is included in the request. The information providing apparatus may confirm whether or not the version included in the acquisition request from the terminal device matches the version of the HTML document currently held in the information providing apparatus. The version may be a value sequentially incremented like 1, 2, 3, . . . in each update, a value identifying update date and time, or a value of other kinds.

In this case, when the version held in the terminal device (the version of the HTML document imparted to the acquisition request made by the terminal device, the version being different from the update information identifier of the element) does not match the version of the current HTML document, the information providing apparatus identifies a difference therebetween as an update portion. The information providing apparatus may perform operation of returning a response, which includes an identifier identifying the location of an identified update portion, information (second update information) indicating a current version of the HTML document held in the information providing apparatus, and an updated content of the update location (first update information). The update location may be a location path in XPath, or when DOM data is created, the update location may be an identifier indicating the location of a pertinent node.

The terminal device may identify a location to be updated in the HTML documents currently held by the terminal device itself, based on the identifier of the update location included in the response, and may overwrite the content of the specified location with the updated content (first update information) included in the response. The version (update information identifier) of the HTML document may also be overwritten with the version (second update information) included in the response. The identifier of this version is included in a next acquisition request. The update portion may be a part or all of the entire HTML document.

As described above, according to the present embodiment, when there is an HTML document which is partially updated on the information providing apparatus side, the structure of the HTML document is comprehended and only the updated portion is transmitted to the terminal device. The terminal device updates only that portion. In that case, when the size of the data added to a request from the terminal device and to a response from the information providing apparatus, i.e., the sum of the size of the data including update information identifiers and headers and the size of an update content, is smaller than the (conventionally acquired) size of the updated entire HTML document, electric power required to acquire the partially updated HTML document can be made lower than that in conventional cases.

### Second Embodiment: Adding Prefetching Function and Sleep Function to Terminal Device

Hereinafter, a second embodiment will be described. In the second embodiment, a function to achieve lower power consumption is added to the terminal device in the first embodiment.

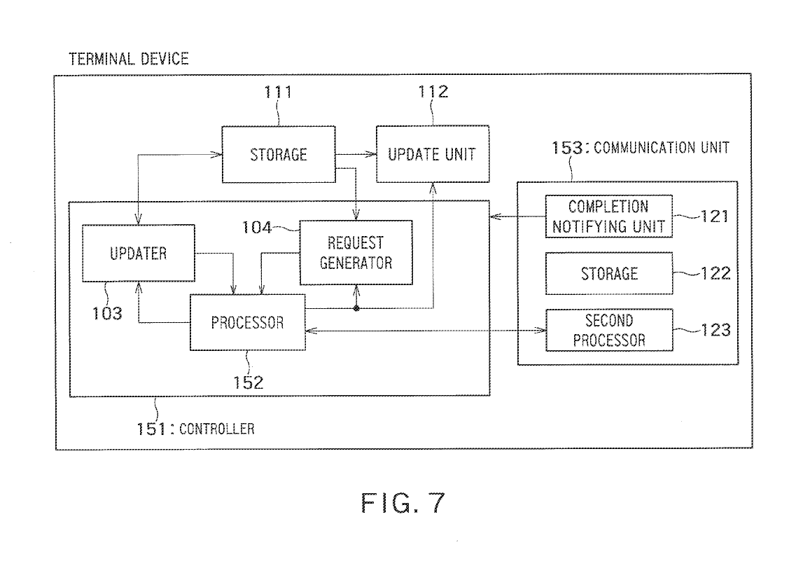

FIG. 7 illustrates the configuration of a terminal device of the present embodiment. The communication unit 113 illustrated in FIG. 2 described in the first embodiment is replaced with a communication unit 153. The communication unit 153 includes a second processor 123, a storage (memory unit) 122, and a completion notifying unit 121. The second processor 123 is lower in power consumption than the controller 151. The controller 151 sends an instruction to transmit an information acquisition request to the communication unit 153. The communication unit 153 transmits an information acquisition request in accordance with the instruction from the controller 151, and executes a process of receiving a response from an information providing apparatus in place of the controller 151 inside the terminal device. After a necessary receiving process is completed, process completion is notified to the controller 151. After sending the instruction to transmit the information acquisition request to the communication unit 153, the controller 151 shifts to a low power consumption state until a notification of process completion is received. Thus, when an update portion of the information is downloaded from the information providing apparatus, the controller 151 shifts to the low power consumption state until the receiving process in the communication unit 153 is completed, so that the entire apparatus can achieve low power consumption. Hereinafter, the details of the present embodiment will be described.

Out of the functions included in the processor 152 inside the controller 151 in the first embodiment, the second processor 123 includes a function of interpreting a message exchanged with an information providing apparatus and a function of acquiring necessary information from the information providing apparatus based on the message. The second processor 123 also includes a function of returning the information stored in the later-described storage 122 to the controller 151.

The storage 122 includes a function of temporarily storing the information that is acquired by the second processor 123 from the information providing apparatus. As stated before, the information stored in the storage 122 can be accessed from the second processor 123.

In response to the instruction from the second processor 123, the completion notifying unit 121 notifies process completion of the second processor 123 to the controller 151. Examples of the notifying method include a method involving hardware interruption. The process completion refers to the state where the information instructed by the controller 151 has been acquired from the information providing apparatus. At the time of process completion, it is not necessary that acquisition of all the information pieces is completed. The process completion may be notified at the time when a part of the information pieces has been acquired. For example, in the case where a constant time is needed to shift the state of the controller 151, the process completion may be notified before all the information pieces are acquired in consideration of the needed time.

Since the communication unit 153 operates independently of the controller 151, a power supply control circuit (not illustrated) in the terminal device is configured so that the communication unit 153 and the controller 151 can individually be controlled.

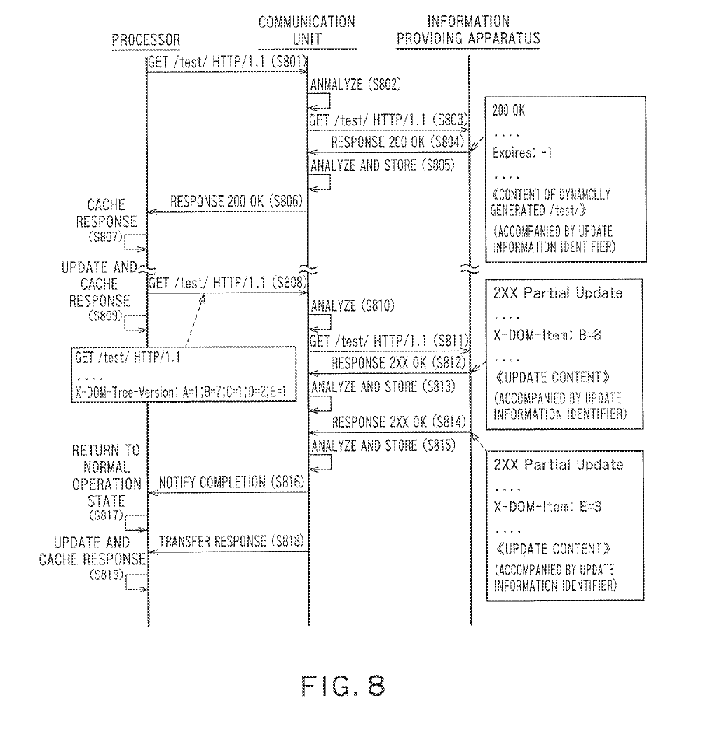

Hereinafter, detailed operation is described with reference to FIG. 8. FIG. 8 illustrates a message sequence among the processor 152 in the controller 151 and the communication unit 153, and the information providing apparatus in the second embodiment.

As in the first embodiment, the controller 151 identifies a URI of the requested information and generates an acquisition request. The controller 151 instructs transmission of an acquisition request to the communication unit 153 (S801). Here, it is assumed that the acquisition request is the first acquisition request which does not include update information identifiers of elements and the like. At this point, the controller 151 does not shift to a low power consumption state, though the controller 151 may be configured so as to shift to the low power consumption state (not illustrated).

The communication unit 153, which received the instruction to transmit the acquisition request from the controller 151, analyzes a content thereof, and confirms that the acquisition request does not include update information identifiers and the like (S802). The communication unit 153 then transmits the acquisition request to an information providing apparatus specified in the acquisition request (S803).

The information providing apparatus receives the acquisition request from the terminal device, and generates an HTML document corresponding to the information subjected to the acquisition request. The information providing apparatus then returns a response including the generated HTML document (S804).

The communication unit 153 which received the response analyzes a content thereof. If it is confirmed to be a response to the acquisition request previously transmitted, the communication unit 153 stores the response in the storage 122 (S805). When the result of analysis indicates that the HTML document received as a response includes a reference to the outside (for example, a reference to image data present in an external server), the communication unit 153 acquires in advance the image and the like before returning the response to the processor 152. The acquired image is stored in the storage 122

When the HTML document (and the information referred therefrom) is received, a response is returned to the processor 152 (S806). At that time, if the controller 151 has shifted to the low power consumption state after step S801, process completion is notified via the completion notifying unit 121, and the controller 151 is made to shift to a normal operating state before the response is returned.

The processor 152 confirms the information (HTML document) included in the response received from the communication unit 153 and then caches the HTML document (S807). The output unit 112 reads out the HTML document from the cache, and displays the HTML document on a screen.

Assume that the terminal device then tries an access to the same URI as in step S801. This time, an acquisition request including the update information identifiers of elements and the like is generated based on the information stored in the storage 111, and an instruction to transmit the acquisition request is notified to the communication unit 153 (S808). After the notification, the controller 151 including the processor 152 shifts to the low power consumption state (S809).

The communication unit 153, which received notification of the instruction to transmit the acquisition request, analyzes the acquisition request (S810), and transmits the acquisition request to the information providing apparatus (S811). The communication unit 153 receives a response from the information providing apparatus (S812, S814), and performs analysis of the response and a process to store the response in the storage 122 (S813, S815). Here, it is assumed that updated contents of individual elements are returned as different HTTP responses. More specifically, as illustrated in FIG. 8, an updated content of the element B is returned in step S812, and an updated content of the element E is returned in step S814. If all the updated contents are notified by one response (as in the case of MIME/Multipart), steps S812 and S814 are collectively executed as one step.

When the communication unit 153 determines that all the responses were received, the communication unit 153 notifies process completion to the processor 152 via the completion notifying unit 121 (S816). Upon reception of the notification, the controller 151 including the processor 152 returns to the normal operating state (S817). Then, the communication unit 153 transfers the response to the processor 152 (S818). While confirming the content thereof, the processor 152 performs an update process (update, deletion, and addition of elements) and the like, based on the update information (update information identifiers of elements, updated contents and the like) included in the response. The processor then caches the result of the update process in the storage 111 (S819).

As mentioned above, in the present embodiment, the second processor 123 which is lower in power consumption than the controller 151 is installed into the communication unit 153, and the second processor 123 acquires information independently of the controller 151. Consequently, while the second processor 123 is acquiring information, the controller 151 can be shifted to the low power consumption state. As a result, information can be acquired at lower power consumption.

### Third Embodiment: Placing Browser Server in Between Terminal Device and Information Providing Apparatus, and Using Functions of Embodiment in Present Invention for Terminal Device and Browser Server

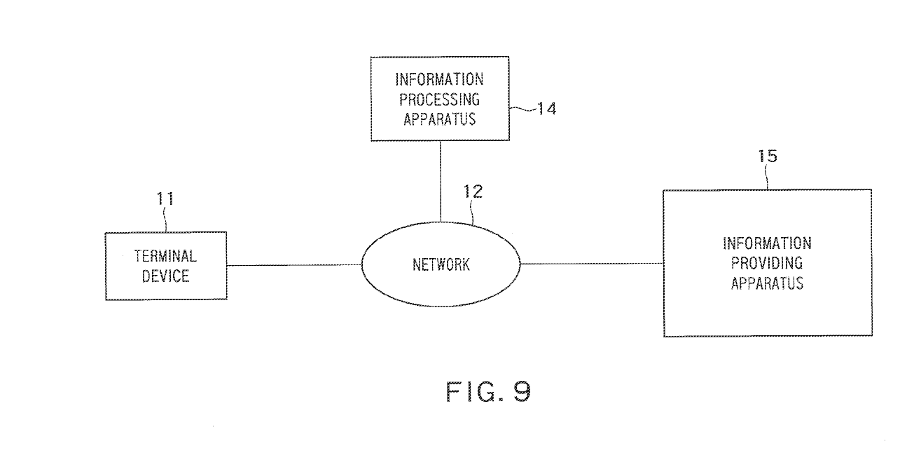

Hereinafter, a third embodiment will be described. FIG. 9 illustrates a network configuration in the present embodiment. In the present embodiment, a terminal device 11 and an information providing apparatus 15 are provided, and an information processing apparatus (browser server) 14 is added to therebetween. The terminal device 11, the information providing apparatus 15, and the information processing apparatus 14 are communication apparatuses each connected to a network 12. Communication is performed between the terminal device 11 and the information processing apparatus 14, and between the information processing apparatus 14 and the information providing apparatus 15.

The information processing apparatus 14 executes some functions separated from browser functions included in the terminal device 11. The terminal device 11 executes a remnant of the separated functions. As the information providing apparatus 15, a server, such as a widely used web server, can be used. Such configuration makes it possible to implement the present invention without changing the information providing apparatus which has already been widely prevalent. Hereinafter, the details of the present embodiment will be described.

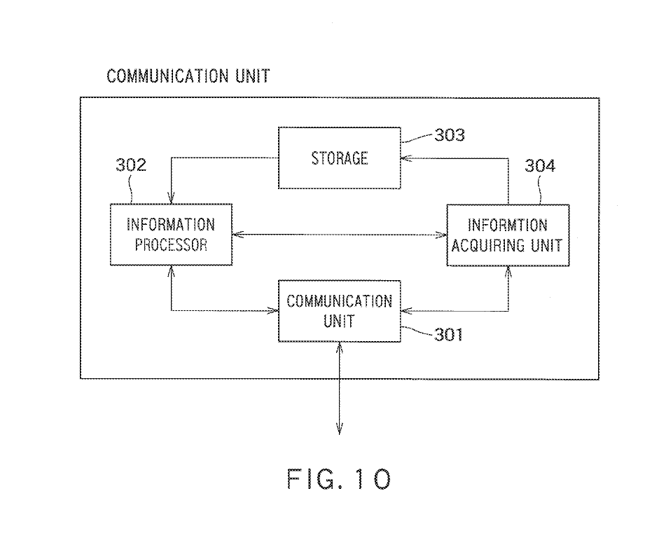

FIG. 10 illustrates a functional block diagram of the information processing apparatus 14.

A communication unit 301 is connected to the network 12, and exchanges messages with respect to information acquisition with the terminal device. The communication unit 301 further exchanges messages with respect to information acquisition with the information providing apparatus 15.

An information acquiring unit 304 acquires information from the information providing apparatus 15 based on an instruction from an information processor 302. A storage 303 temporarily stores the information acquired in the information acquiring unit 304.

The information processor 302 analyzes an acquisition request received from the terminal device. In accordance with an analysis result, the information processor 302 requests acquisition of information to the information acquiring unit 304, and processes the information acquired from the information providing apparatus 15 by the information acquiring unit 304.

For example, the information processor 302 performs some of the process, which is necessary for display in the terminal device 11, on the information acquired from the information providing apparatus 15, and sends back the information to the terminal device 11. Here, the some of the necessary process includes, for example, analyzing structurized documents, recompressing images, and collecting and converting information pieces provided from a plurality of information providing apparatuses into one HTML document.

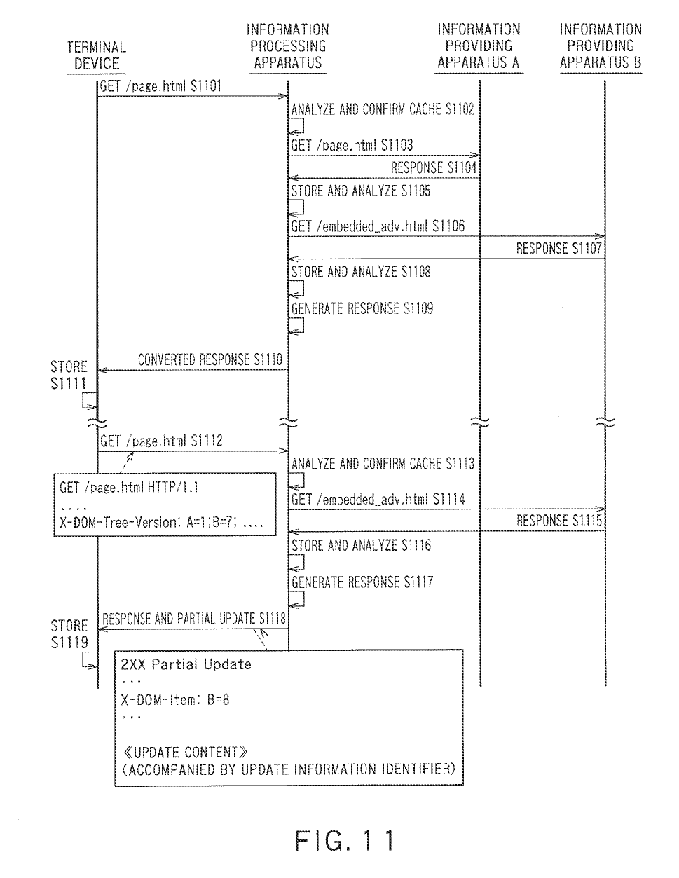

FIG. 11 illustrates an operating sequence in the present embodiment. To makes it easy to understand the effect of the information processing apparatus, FIG. 11 illustrates the case where two information providing apparatuses (apparatuses A and B) are present. Assume that the information providing apparatus A provides an entire HTML document, while the information providing apparatus B provides an HTML document that constitutes a part of the former HTML document. An information acquisition request, including update information identifiers of elements and the like, and a response thereto are exchanged between the terminal device 11 and the information processing apparatus 14. Between the information processing apparatus 14 and the information providing apparatuses A and B, standard HTTP communication is performed. The information processing apparatus 14 can detect whether or not the information held in the information providing apparatuses A and B is changed in accordance with a cache management method prescribed by the HTTP.

First, the terminal device 11 requests acquisition of object information (S1101). The information processing apparatus 14 receives this acquisition request. The information processing apparatus 14 analyzes the acquisition request, and confirms whether or not the object information is accumulated in the own storage 303 as a cache (S1102).

Here, it is assumed that the acquisition request is made for the first time so that a cache is not present. The information processing apparatus 14 requests acquisition of the information (HTML document) to the information providing apparatus A that is specified in the acquisition request (S1103). The information providing apparatus A returns a response including the information (S1104). The information processing apparatus 14 stores the received response in the storage 303 and then analyzes the information. As a result, the information processing apparatus 14 determines that information to be embedded in the HTML document (embedded_adv.html) needs to be acquired (S1105).

The information processing apparatus 14 requests acquisition of the embedded information to the information providing apparatus B (S1106), and receives a response thereto (S1107). The information processing apparatus 14 stores in the storage 303 information included in the received response, and analyzes the information (S1108). Here, the information processing apparatus 14 determines that further acquisition of information is not necessary.

The information processing apparatus 14 generates a response to be returned to the terminal device (S1109). Here, the information processing apparatus 14 performs conversion to make the information pieces acquired from the plurality of information providing apparatuses A and B (HTML documents) into one piece of information. Furthermore, in the process of this conversion, update information identifiers are allotted to respective elements which constitute the information. The update information identifiers may be allotted in any method as long as values of the identifiers are changed in each update.

Once the plurality of information pieces (HTML documents) are converted into one piece of information, a response including the converted information (also including the update information identifiers of the respective elements) is returned to the terminal device (S1110). The terminal device stores the information (S1111).

Then, it is assumed that the terminal device generates an acquisition request to the same URI as in step S1101. At this time, the terminal device generates an acquisition request including the update information identifiers of the respective elements and the like. The terminal device sends the generated acquisition request to the information processing apparatus (S1112).

The information processing apparatus which received the acquisition request analyzes the acquisition request, and confirms whether or not the object information is cached in the storage 303 (S1113). This time, since the URI has been accessed in the past, the information (HTML documents) corresponding to the URI has been stored as a cache. However, it is assumed that among the stored HTML documents, the embedded information acquired from the information providing apparatus B is expired (the valid term is determined based on the cache management method prescribed by the HTTP). As a result, the information processing apparatus 14 transmits a request to acquire the embedded information to the information providing apparatus B (S1114), and obtains a response thereto (S1115). Then, the information processing apparatus 14 stores the embedded information included in the response and analyzes the information (S1116).

As a result of the analysis, the information processing apparatus 14 determines that further acquisition of information is unnecessary, and generates a response to the terminal device (S1117). The response includes an update information identifier of the updated element (embedded information). The response is also designed to inform only the information (an updated content of the pertinent element) which is assumed to have been changed and which is acquired from the information providing apparatus B.

The information processing apparatus 14 returns the generated response to the terminal device (S1118). The terminal device stores the embedded information, the update information identifiers, and the like included in the received response (S1119). The entire HTML document reflecting the acquired embedded information is displayed (S1119).

Thus, in the present embodiment, efficient information transfer can be implemented by placing the information processing apparatus 14 for the widely diffused general information providing apparatuses. Although the example in which information is acquired from two information providing apparatuses have been described, the number of the information providing apparatuses may be one (it is general that one information providing apparatus provides a plurality of embedded information pieces (fragments)), or may be two or more.

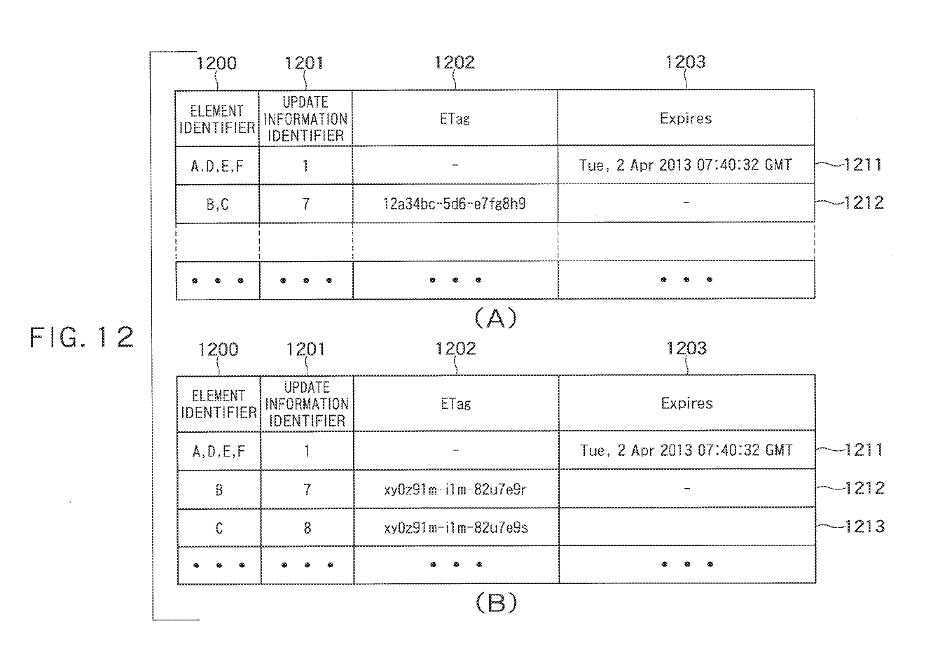

Here, in the present embodiment, the information processing apparatus 14 needs to maintain cache control prescribed by the HTTP, and a correspondence relation between element identifiers and update information identifiers. Accordingly, management information as illustrated in FIG. 12 may be used for example. The management information is commonly applied to a plurality of terminal devices that communicate with the information processing apparatus.

The management information illustrated in FIG. 12A is an example of management information corresponding to the information (page.html in the example illustrated in FIG. 11) transmitted from the information processing apparatus to the terminal device as a response. A column 1200 indicates respective elements included in the information (which may not all the elements but be partial update object elements), a column 1201 indicates update information identifiers representing the version of the elements, a column 1202 indicates Etag header values written on the HTTP header when the information (page.html) is acquired, and a column 1203 indicates Expires header values.

A row 1211 relates to the elements included in the entire page (page.html) acquired from the information providing apparatus A (herein, elements A, D, E and F are indicated to be present as elements to be partially updated). Since one Expires header is included in one HTTP message, these four elements are associated with an identical Expires value.

Similarly, in a row 1212, an Etag header obtained when an embedded fragment (embedded.html) is acquired from the information providing apparatus B is associated with the elements B and C included in the embedding fragment.

Consider the case where the information providing apparatus B updates only a part of information. The update of information can be detected by performing a process of extracting difference between the acquired information and the elements stored in the storage 303. In this case, the Etag or Expires portion gains new values, and so the update information identifiers of some updated elements are changed. FIG. 12B illustrates an example in which update of the element C is detected and thereby the update information identifier of the element C is updated from 7 to 8. A new row 1213 including the element C, an update information identifier 8, and a changed Etag (xy0z91m-ilm-82u7e9s) is added. In relation thereto, the element C is deleted from the row 1212.

In the example of FIG. 12, two headers of Etag and Expires are used, though the same operation may apply in the case of other headers that manage the cache and the validity term. Thus, validity term information is managed in accordance with the response returned from each information providing apparatus, the update information identifiers are managed in association with the validity term information, and the update information identifiers and the updated elements are returned to the terminal device. This enables the terminal device to perform update in units of respective elements that constitute original information. Furthermore, the number of requests to acquire information can be reduced (for example, no request to acquire embedded information is generated). In addition, since a part of the browser functions of the terminal device is shifted to the information processing apparatus, low power consumption in the terminal device can be achieved.

### Modification of Third Embodiment

In the third embodiment, the terminal device operates a web browser to perform HTTP communication between the terminal device and the information processing apparatus. Instead, exclusive software and/or communications protocols with higher processing efficiency may be used.

For example, the information processing apparatus may create DOM data (tree structure), serialize the DOM data by an appropriate method (which involves, for example, binary strings and XML, the converting method to be used is shared in advance by the terminal device and the information processing apparatus), and may transfer the serialized data to the terminal device. The terminal side may implement a function so that the data is restored and immediately displayed. The information processing apparatus may serialize an HTML document acquired from the information providing apparatus, and may transmit the serialized data. The information processing apparatus manages the update information identifiers of the elements that constitute DOM data which is transmitted to the terminal device. When any content collected from the information providing apparatus is changed, the information processing apparatus may notify only the changed elements to the terminal device.

In still another method, the information processing apparatus may generate an HTML document to be displayed in the terminal device as image(s). Then, the information processing apparatus may transmit to the terminal device the image, link information included in the HTML document (for example, <A ref=“http:// . . . />”), and update information identifiers set for each area of the image, together with the identifiers (update location identifiers) of each area. The link information is associated with an area or coordinates on the image. When there is an update in a response to the terminal device, the information processing apparatus generates an image limited to a difference portion, and transmits the image to the terminal device together with an update information identifier. An updated portion may be detected by analyzing the structure of the document and by using such information as the validity term and the ETag header as described in the embodiments disclosed. It is also possible to generate the entire document as an image and to compare images to obtain a difference image. Since the image does not include information on document structure, coordinate and/or area information and their update information identifiers may be associated with the image.

The terminal device, which received the image, the link information, and the update information identifier, updates information of an area having a difference, among the image information stored in the storage. Then, the terminal device displays the updated image. In the terminal device, when a user clicks or the like to select an area that is associated with the link information, the terminal device starts an access to the link information. Or alternatively, clicked coordinates may be transmitted to the information processing apparatus. The information processing apparatus may identify link information based on the coordinates and may start operation to acquire the linked information. In this case, it is not necessary to transmit the link information to the terminal device.

When the link information is updated, the same operation may apply. More specifically, the information processing apparatus extracts an update portion of the link information, and transmits the result in association with the update information identifier of an area related to the link information. Since the link information is the information that stores the correspondence relation between the area on the image and the link destination, it is easy to confirm an update portion of the link information in response to the area on the image. The terminal device may also partially update the link information when a difference of the link information is notified.

As described above, even when the information processing apparatus and the terminal device use the communications protocol which involves a smaller amount of overheads instead of the HTTP, implementation of the present invention can be achieved.

### Fourth Embodiment: Adding Prefetching Function and Sleep Function to Terminal Device While Placing Browser Server to Use Functions of the Embodiment in Present Invention for Terminal-Browser Server

The same configuration as in the second embodiment may be used for the terminal devices in the third to fourth embodiments. In that case, while the terminal devices perform operation as described in each embodiment, only the communication unit operates during acquisition of information. Accordingly, further reduction in power consumption can be expected.

### Fifth Embodiment: Placing Browser Server in Between Terminal Device and Information Providing Apparatus, and Using Functions of Embodiment in Present Invention for Between Browser Server and Web Server

In the third embodiment (FIGS. 9 to 12), the process according to the embodiment of the present invention is performed in between the terminal device and the information processing apparatus (browser server). In a fifth embodiment, the process according to the embodiment of the present invention is performed in between an information processing apparatus and an information providing apparatus (web server).

In the present embodiment, the terminal device sends a request to acquire information to the information processing apparatus. The information processing apparatus requests again the information requested by the terminal device to the information providing apparatus. In this case, the information processing apparatus performs operation equivalent to the operation of the terminal device illustrated in the first embodiment. Once all the information pieces requested by the terminal device have been acquired from the information providing apparatus, the information processing apparatus performs operation of the information processing apparatus described in the third embodiment (the processes necessary for the terminal device such as an image conversion process and a process of making a plurality of HTML documents into one document). The information processing apparatus then returns a response to the terminal device. When the information requested by the terminal device has not at all changed from the time of the previous request, a response notifying no change is returned.

By this operation, the terminal device can acquire necessary information in one request, and the time taken for the processes performed between the information processing apparatus and the information providing apparatus can be reduced. As a result, reduction in power consumption can be achieved as a whole. A sleep function may be added to the terminal device of the present embodiment as in the second embodiment, so that the terminal device may shift to a low power consumption state during a period from transmission of an acquisition request to return of a response.

The terminal device, the information providing apparatus and the information processing apparatus as described above may also be realized using a general-purpose computer device as basic hardware. That is, each block of in the terminal device, the information providing apparatus and the information processing apparatus can be realized by causing a processor mounted in the above general-purpose computer device to execute a program. In this case, the terminal device, the information providing apparatus and the information processing apparatus may be realized by installing the above described program in the computer device beforehand or may be realized by storing the program in a storage medium such as a CD-ROM or distributing the above described program over a network and installing this program in the computer device as appropriate. Furthermore, the storage may also be realized using a memory device or hard disk incorporated in or externally added to the above described computer device or a storage medium such as CD-R, CD-RW, DVD-RAM, DVD-R as appropriate.

Furthermore, the terminal device, the information providing apparatus and the information processing apparatus may include a CPU (Central Processing Unit), a ROM (Read Only Memory) and a RAM as one example of circuitry. In this case, each unit or each element in the terminal device, the information providing apparatus and the information processing apparatus can be controlled by a CPU's reading out into a RAM and executing a program which is stored in a storage or ROM.

Also, the above-stated hardware configuration is one example and a part or all of the terminal device, the information providing apparatus and the information processing apparatus according to an embodiment can be realized by an integrated circuit such as a LSI (Large Scale Integration) or an IC (Integrated Circuit) chip set as one example of circuitry. Each function block in the terminal device, the information providing apparatus and the information processing apparatus can be realized by a processor, individually, or a part or all of the function blocks can be integrated and realized by one processor. A means for the integrating the part or all of the function blocks is not limited to the LSI and may be dedicated circuitry or a general-purpose processor.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A communication apparatus, comprising:
a storage to store object information including first to N-th elements, and first to N-th update information identifiers identifying versions of the first to N-th elements;
a transmitter to transmit an acquisition request including all or a part of the first to N-th update information identifiers to an acquisition target apparatus via a network;
a receiver to receive, from the acquisition target apparatus, first update information to update at least one element among the elements whose update information identifiers were transmitted in the acquisition request and second update information to update the update information identifier of the at least one element; and
an updater to update the at least one element in the storage with the first update information and to update the update information identifier of the at least one element with the second update information.

2. A communication apparatus, comprising:
a storage to store object information and a first update information identifier that identifies a version of the object information;
a transmitter to transmit a first acquisition request including the first update information identifier to an acquisition target apparatus via a network;
a receiver to receive, from the acquisition target apparatus, first update information to update at least a part of the object information and second update information to update the first update information identifier; and
an updater to update at least a part of the object information in the storage with the first update information and to update the first update information identifier with the second update information.

3. The communication apparatus according to claim 1, comprising:
a communication unit including the transmitter and the receiver; and
a controller including the updater, wherein
the controller outputs an instruction to transmit the acquisition request to the communication unit, and then shifts from a first state to a second state, the second state being lower in power consumption than the first state,
the communication unit transmits the acquisition request in response to the instruction, and outputs a completion notification to the controller when reception of the first update information and the second update information from the acquisition target apparatus is completed, and
the controller shifts from the second state to the first state upon reception of the completion notification from the communication unit.

4. The communication apparatus according to claim 3, wherein
when the first update information acquired from the acquisition target apparatus includes a link to information held in an external server, the communication unit acquires the information from the external server according to the link, and outputs the completion notification after acquisition of the information from the external server is completed.

5. The communication apparatus according to claim 1, wherein
the storage stores the object information in association with an URI,
the communication apparatus comprises a processor to receive from a request source an acquisition instruction with an URI specified, and to determine whether or not the object information corresponding to the URI specified is stored in the storage, and
when the object information is stored in the storage, the transmitter transmits the acquisition request to the acquisition target apparatus whereas when the object information is not stored in the storage, the transmitter transmits to the acquisition target apparatus a request to acquire the object information corresponding to the URI specified by the acquisition instruction.

6. The communication apparatus according to claim 1, wherein
the first to N-th elements are component members of a document described in tag description language.

7. The communication apparatus according to claim 6, wherein
the first to N-th elements are values allotted to nodes in a tree structure obtained by analyzing the structure of the document.

8. The communication apparatus according to claim 2, wherein
the first update information includes an update location identifier indicating an update location in the object information and data to update information at the update location in the object information.

9. A communication apparatus, comprising:
a receiver to receive an acquisition request from a request source apparatus via a network, the request source apparatus holding object information including first to N-th elements and holding first to N-th update information identifiers identifying versions of the first to N-th elements, the acquisition request including all or a part of the first to N-th update information identifiers;
a processor to determine whether or not to update the elements whose update information identifiers were included in the acquisition request, according to the update information identifiers included in the acquisition request; and
a transmitter to transmit, to the request source apparatus, first update information to update the elements determined to be updated by the processor and second update information to update the update information identifiers of the elements determined.

10. The communication apparatus according to claim 9, comprising:
a storage to store update information identifiers respectively indicating versions of the first to N-th elements, wherein
when the versions of the elements whose update information identifiers were included in the acquisition request are different from those of the elements managed in the storage, the processor determines to overwrite the elements and the update information identifiers thereof in the request source apparatus with the elements and the update information identifiers thereof managed in the storage.

11. The communication apparatus according to claim 9, wherein
the first to N-th elements are component members in a document described in tag description language.

12. The communication apparatus according to claim 11, wherein
the first to N-th elements are values allotted to nodes in a tree structure obtained by analyzing the structure of the document.

13. A communication apparatus, comprising:
a receiver to receive, from a request source apparatus holding object information and a first update information identifier identifying a version of the object information, an acquisition request including the first update information identifier via a network;
a processor to determine whether or not to update the object information held in the request source apparatus based on the first update information identifier included in the acquisition request; and
a transmitter to transmit to the request source apparatus, when the processor determines to update the object information held in the request source apparatus, first update information to update at least a part of the object information and second update information to update the first update information identifier held in the request source apparatus.

14. A communication method, comprising:
transmitting an acquisition request to an acquisition target apparatus via a network, the acquisition request including all or a part of first to N-th update information identifiers of first to N-th elements forming object information;
receiving, from the acquisition target apparatus, first update information to update at least one element among the elements whose update information identifiers were transmitted in the acquisition request and second update information to update the update information identifier of the at least one element; and
updating the at least one element with the first update information and updating the update information identifier of the at least one element with the second update information.

15. A communication method, comprising:
transmitting a first acquisition request including first update information identifier that identifies a version of object information to an acquisition target apparatus via a network;
receiving, from the acquisition target apparatus, first update information to update at least a part of the object information and second update information to update the first update information identifier; and
updating at least a part of the object information with the first update information and updating the first update information identifier with the second update information.
